(19) United States
(12) Patent Application Publication
(10) Pub. No.: US 2004/0071610 A1
(43) Pub. Date: Apr. 15, 2004

(54) Customized flow path substrate

(76) Inventors: Annette M. Brenner, Honeoye Falls, NY (US); Tai-Chiang Yu, Pittsford, NY (US); Mark A. Brundage, Pittsford, NY (US); Gerald E. Voecks, Fairport, NY (US)

Correspondence Address: HARNESS, DICKEY & PIERCE, P.L.C., P.O. BOX 828, BLOOMFIELD HILLS, MI, 48303, US

(21) Appl. No.: 10/270,826

(22) Filed: Oct. 15, 2002

(51) Int. Cl. B01D 53/34

(52) U.S. Cl. 422/177; 422/180; 422/211; 29/890; 422/222

(57) ABSTRACT

A customized flow path substrate is provided that comprises fins of varying material and geometry within a catalyst bed of fuel processing reactors. The fins are preferably secured to a core and are assembled by winding the fins around the core and placing the wound fins and the core into a tube to form a tube assembly, which is positioned within the fuel processing reactor. Either one or a plurality of fins may be secured to an individual core, wherein either or both the material and the geometry are varied to customize the flow path and to provide for efficient mixing of gases and to break boundary layer between bulk gas stream and substrate for enhancing mass transfer rate. In addition, the fins are coated with a catalyst material either prior to assembly in one form or after assembly within the tube in another form of the present invention.

### FIELD OF THE INVENTION

The present invention relates generally to fuel cell systems and more particularly to substrates within catalytic sections of fuel processing reactors that are utilized to customize flow paths to provide for efficient mixing of the reacting gases and to break boundary layer between bulk gas stream and substrate for enhancing mass transfer rate therein.

### BACKGROUND OF THE INVENTION

Fuel cells have been used and are being further investigated as a power source in a variety of applications. For instance, fuel cells have been proposed for use in electrical vehicular power plants to replace internal combustion engines. In a particular type of fuel cell, namely a proton exchange membrane (PEM) fuel cell, hydrogen (H₂) is supplied to an anode of the fuel cell and oxygen (O₂) is supplied as an oxidant to a cathode. Generally, PEM fuel cells further comprise a membrane electrode assembly (MEA) that includes a thin, proton transmissive, non-electrically conductive solid polymer electrolyte membrane having an anode catalyst on one face and a cathode catalyst on an opposite face. The MEA is disposed between a pair of electrically conductive elements that (1) serve as current collectors for the anode and cathode, and (2) contain appropriate channels and/or openings therein for distributing gaseous reactants of the fuel cell over surfaces of the respective anode and cathode catalysts.

In PEM fuel cells, H₂ is the anode reactant (i.e., fuel) and O₂ is the cathode reactant (i.e., oxidant). The H₂ fuel may be contained in a reformate (˜40-50% by volume) or as “pure” H₂. The O₂ can be either a pure form, or air (a mixture of O₂ and N₂), or O₂ in combination with other gases.

For vehicular applications, hydrocarbons (e.g., gasoline) are highly desirable as a hydrogen source for the fuel cell. Such liquid fuels are easily stored onboard the vehicle and there exists a nationwide infrastructure for supply of the fuels. Alternative fuel options include alcohol (e.g., methanol or ethanol) and natural gas. However, such fuels must be dissociated to release the hydrogen content thereof for fueling the fuel cell, wherein the dissociation reaction is accomplished within a chemical fuel processor. The fuel processor contains one or more reactors wherein the fuel reacts with steam (as in steam reforming), and often times air, to yield a reformate gas comprising primarily H₂ and carbon dioxide (CO₂). For example, in the gasoline autothermal reformation process, steam, air, and gasoline are reacted in the first or primary reactor in which two reaction types take place. The inlet section of the primary reactor primarily promotes a partial oxidation reaction (POX) of air and fuel which provides the thermal conditions for promoting steam reforming (SR), the reaction of steam and hydrocarbons, in the exit section. The primary reformer products are basically H₂, CO₂, and carbon monoxide (CO). Reactors downstream of the primary reactor may include water gas shift (WGS) and preferential oxidation (PrOx) reactors. The WGS reactor is responsible for converting as much CO as possible into CO₂ by reacting CO with steam. The additional H₂ produced from the reaction, CO+H₂O⇄CO₂+H₂, is essential to the system efficiency. In the PrOx, CO₂ is produced from CO using O₂ from air as an oxidant. Accordingly, control of air feed is important to selectively oxidize CO to CO₂ via to CO+½O₂→CO₂, in preference to H₂ oxidation to water (H₂O) via H₂+½O₂→H₂O.

Within the fuel processing reactors, catalyst beds are typically provided wherein reactions take place to convert, for example, the fuel, water, and possibly air, into a hydrogen rich product. The catalyst beds generally comprise a substrate or a plurality thereof on which a catalyst is secured. The catalyst substrate may take many forms, such as foams, honeycomb, or a corrugated core, all with catalyzed walls. Moreover, a typical reactor may include a plurality of reaction tubes, wherein supported catalyst is contained. Typically, the substrates of the known art are generally fabricated from a single material type and comprise a uniform geometry throughout the tubes within the catalyst bed. As a result, the flow path for the gasses that pass through the catalyst bed may not be customized for the particular type of reactor and the particular fuel cell system. Further, the weight of the reactor may not be optimized with the single material types and the consistent geometries of known art substrates.

Accordingly, there remains a need in the art for a substrate within the catalyst bed of a fuel processing reactor that is capable of customizing the flow path according to various operating conditions and types of fuel cell systems. Further, a need exists for a substrate that provides for efficient gas mixing throughout the catalyst bed and that is compact and lightweight. In summary, a combined fluid dynamic variable in combination with reaction variables can be improved by customized design of the catalyst substrate

Fuel cell systems that process a hydrocarbon fuel to produce a hydrogen-rich reformate for consumption by PEM fuel cells are known and are described in U.S. Pat. Nos. 6,232,005, 6,077,620, and 6,238,815, each of which is assigned to General Motors Corporation, assignee of the present invention and is herein incorporated by reference. A typical PEM fuel cell and its MEA are described in U.S. Pat. Nos. 5,272,017 and 5,316,871, each of which are also assigned to General Motors Corporation and are herein incorporated by reference.

### SUMMARY OF THE INVENTION

In one preferred form, the present invention provides a customized flow path substrate comprising one or a plurality of fins with varying materials and/or geometries within a catalyst bed of a fuel processing reactor. The fins are preferably secured to a core and the bed is assembled by winding the fins around the core and placing the wound fins along with the core into a tube. The fins may comprise a variety of materials such as steels br any of several metal alloys which are shaped to customize the flow path of gases through the reactor. Additionally, the fins may further comprise a variety of geometries, including, but not limited to, crest fins, lanced fins, herringbone fins, perforated fins, louvered fins, and/or variegated fins, or a combination thereof, to further customize the flow path in a particular section of the reactor and to provide for efficient mixing between the sections or within a section depending on the type of fin.

The fins are preferably secured to the core and are wound around the core and placed into a tube for assembly. A catalyst washcoat is applied to at least a portion of the fins either prior to or after assembly within the tubes. According to one method, the fins are secured to the core and the catalyst washcoat is then applied to at least a portion of the fins. The coated fins are then wound around the core and placed into the tube. According to another method, the fins are secured to the core, wound around the core, and placed into the tube, and the catalyst washcoat is then applied to at least a portion of the fins after assembly within the tube. Moreover, the thickness and surface area of the catalyst washcoat may be varied according to particular flow path needs.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic flow diagram of an exemplary fuel cell system in accordance with the present invention;

FIG. 2 is a side view of a fin secured to a core in accordance with a customized flow path substrate of the present invention;

FIG. 3A is a schematic perspective view of a reactor having a plurality of customized flow path substrates according to the principles of the present invention;

FIG. 3B is a schematic end view of the reactor shown in FIG. 3A;

FIG. 4 is a top view of a fin rolled around a core in accordance with a customized flow path substrate of the present invention;

FIG. 5A illustrates a core and fin being inserted in a tube according to the principles of the present invention;

FIG. 5B illustrates a tube assembly according to the principles of the present invention;

FIG. 6A is a schematic perspective view of a reactor having a large assembly according to the principles of the present invention; and

FIG. 6B is a schematic end view of the reactor shown in FIG. 6A.

FIG. 7A is a side view of a plurality of fins secured to a core in accordance with an exemplary customized flow path substrate according to the principles of the present invention;

FIG. 7B is a side view of a plurality of fins secured to a core in accordance with an attentive exemplary customized flow path substrate according to the principles of the present invention;

### DETAILED DESCRIPTION OF THE PREFERRED EMBODIMENT

The following description of the preferred embodiments is merely exemplary in nature and is in no way intended to limit the invention, its application, or uses.

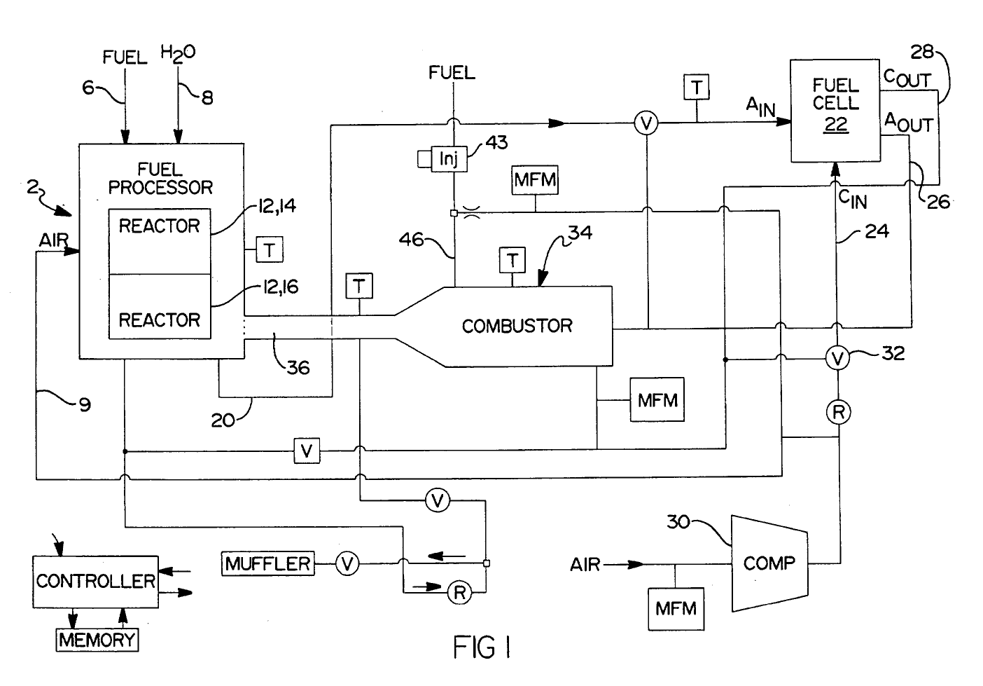

The present invention generally provides a customized flow path substrate for use in catalyst beds of fuel processing reactors. The flow path may be further understood with reference to the exemplary fuel cell system shown in FIG. 1. Accordingly, the following description is provided to more fully understand the system within which the customized flow path substrate is employed.

Referring to FIG. 1, an exemplary fuel cell system is shown, which may be used in a vehicle (not shown) as an energy source for propulsion. In the system, a hydrocarbon is processed in a fuel processor, for example, by reformation, water-gas shift, and preferential oxidation processes, to produce a reformate gas that has a relatively high hydrogen content.

The present invention is herein described in the context of a fuel cell fueled by a hydrogen-rich reformate regardless of the method by which such reformate is made. It shall be understood by those skilled in the art that the principles embodied herein are applicable to fuel cells fueled by hydrogen obtained from any source, including reformable hydrocarbon and hydrogen-containing fuels such as methanol, ethanol, gasoline, other alkene, aliphatic or aromatic hydrocarbons, natural gas, or from fuel stored onboard such as hydrogen.

As shown in FIG. 1, a fuel cell apparatus includes a fuel processor 2 for catalytically reacting a reformable hydrocarbon fuel stream 6, and water in the form of steam from a water stream 8. In some fuel processors, air is also used in a combination partial oxidation/steam reforming reaction. Accordingly, the fuel processor 2 as described herein also receives an air stream 9. Further, the fuel processor 2 contains one or more reactors 12 wherein the reformable hydrocarbon fuel in stream 6 undergoes dissociation in the presence of water/steam 8 and sometimes air (in air stream 9) to produce the hydrogen-rich reformate. Additionally, each reactor 12 may comprise one or more catalyst beds, wherein there may exist one or more sections of beds along with a variety of designs. Therefore, the selection and arrangement of reactors 12 may vary according to a particular application. Exemplary fuel reformation reactor(s) 14 and downstream reactor(s) 16 are described in greater detail below.

In an exemplary steam/methanol reformation process, methanol and H₂O (as steam) are ideally reacted in a reactor 14 to generate H₂ and CO₂ as previously described. As a result of the reformation process, CO is also produced in addition to the H₂ and CO₂. In an exemplary gasoline reformation process, steam, air, and gasoline are reacted in a fuel processor that comprises a reactor 14 having two sections. One section of the reactor 14 is primarily a partial oxidation reactor (POX), and the other section of the reactor is primarily a steam reformer (SR). As in the case of methanol reformation, gasoline reformation produces H₂ and CO₂, as well as CO. Therefore, after each type of reformation, the CO content of the product stream is preferably reduced to prevent poisoning of the PEM anode catalyst by CO.

Accordingly, a typical fuel processor further includes one or more downstream reactors 16, such as WGS and PrOx reactors. These reactors may be single or multi-stage reactors. The WGS is used to produce CO₂ and additional H₂ from reactions of CO and H₂O as previously described. Preferably, the WGS outlet reformate gas stream that comprises H₂, CO₂, CO, and H₂O is further treated in a PrOx reactor 16 to reduce the CO therein to acceptable levels, by oxidation to CO₂. During a running mode, the H₂ rich reformate 20 is fed into the anode chamber of a fuel cell stack 22. Simultaneously, O₂ (e.g., air) from an oxidant stream 24 is fed into the cathode chamber of the fuel cell 22. Accordingly, the H₂ from the reformate stream 20 and the O₂ from the oxidant stream 24 react in the fuel cell 22 to produce electricity and H₂O. As a further result of the reaction within the fuel cell 22, exhaust or effluent 26 from the anode side of the fuel cell 22 contains an amount of unreacted H₂. Similarly, the exhaust or effluent 28 from the cathode side of the fuel cell 22 contains an amount of unreacted O₂.

As shown, air for the oxidant stream 24 is provided by an air supply, which is preferably a compressor 30. During start-up, the valve 32 is actuated to provide air directly to the input of a combustor 34, wherein the air reacts with a fuel supplied through line 46 to generate a heat of combustion, which is used to heat various parts of the fuel processor 2.

Some of the reactions that occur in the fuel processor 2 are endothermic and require the addition of heat, while other reactions are exothermic and require the removal of heat. Typically, the PrOx reactor 16 requires removal of heat, while one or more of the reformation reactions in reactor 14 are typically endothermic and require heat to be added. The addition of heat for the reformation reactions in reactor 14 is accomplished by preheating reactants, namely, fuel 6, steam 8, and air 9, and/or by heating selected reactors, and by POX reaction.

As further shown, heat from the combustor 34 heats selected reactors and catalyst beds in the fuel processor 2 during start-up. The combustor 34 achieves heating of the selected reactors 14, 16 and beds in the fuel processor as necessary by indirect heat transfer, wherein the indirectly heated reactors 14, 16 comprise a reaction chamber with an inlet and an outlet. Furthermore, the beds within the reaction chamber are in the form of carrier member substrates, described in detail hereinbelow. Each carrier member substrate carries catalytically active material for accomplishing the desired chemical reactions. In addition, the combustor 34 may be used to preheat the fuel 6, water 8, and air 9 that are being supplied as reactants to the fuel processor 2.

The amount of heat demanded by the selected reactors within the fuel processor 2, which is to be supplied by the combustor 34, is dependent upon the amount of fuel and water input and ultimately the desired reaction temperature in the fuel processor 2. As previously set forth, the combustor 34 utilizes all anode exhaust or effluent 26 and potentially some hydrocarbon fuel 46 to supply heat for the fuel processor 2. Accordingly, enthalpy equations are used to determine the amount of cathode effluent 28 to be supplied to the combustor 34 to meet the temperature requirements of the combustor 34.

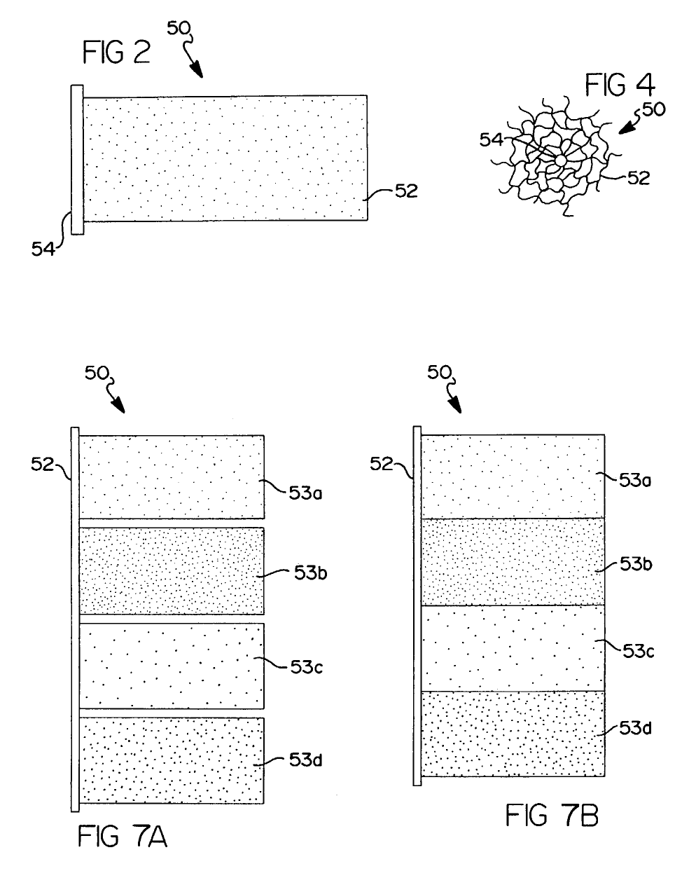

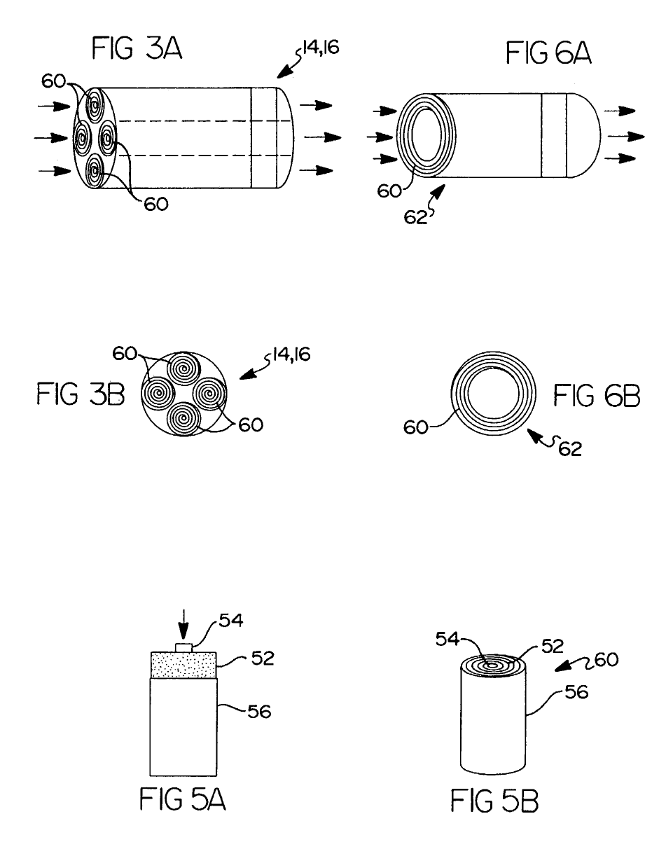

Referring now to FIG. 2, a customized flow path substrate according to the present invention is illustrated and generally indicated by reference numeral 50. The customized flow path substrates 50 are disposed in the reactors 14, 16, as illustrated in FIGS. 3A and 3B. As shown, the customized flow path substrate 50 comprises a fin 52 secured to a core 54. The fin 52 may comprise a variety of materials such as steel or metal alloys, depending on the requirements of a particular fuel processing reactor (not shown). Further, the fin 52 may comprise a variety of geometries (not shown), including, but not limited to, crest fins, lanced fins, herringbone fins, perforated fins, louvered fins, and/or variegated fins, or a combination thereof, to further customize the flow path in a particular section of the reactor and to provide for efficient mixing between the sections or within a section depending on the type of fin. Moreover, the fin 52 is preferably joined to the core 54, which is also a metal material. Accordingly, either or both the material and the geometry of the fin 52 may be varied to customize the flow path and to efficiently mix gases within a fuel processing reactor 14, 16. The geometry is further designed to prevent any location of the bed to be deformed as a result of “nesting” of one layer of fins onto another adjacent layer.

As shown in FIG. 4, the fin 52 is wound around the core 54 prior to being assembled within a tube 56 which is inserted in the catalyst bed of a fuel processing reactor 14, 16. Once the fin 52 is wound around the core 54 and placed in a tube 56 (FIGS. 5A, 5B), a tube assembly 60 (FIG. 5B) is formed, and the tube assembly 60 is positioned within a fuel processing reactor (best shown in FIG. 3A), along with other tube assemblies containing a fin 52 having the same or different materials and geometries as previously set forth. According to an alternative embodiment as illustrated in FIGS. 6A and 6B, a reactor 62 having a single large tube and fin assembly 60 is provided. Furthermore, the fins 52 and the tube assemblies 60 are tailored accordingly to meet the specific requirements of the particular fuel processing reactor 14, 16.

In one form of the present invention, the fin 52 is coated with a catalyst washcoat (not shown) before being placed in the tube with the core 54. Accordingly, the catalyst washcoat is applied to at least a portion of the fin 52 after the fin 52 is secured to the core 54. The coated fin 52 is then wound around the core 54, and then the wound fin 52 and the core 54 are placed within the tube to form the tube assembly 60. The catalyst washcoat may be further tailored to the specific flow path and mixing requirements by varying the thickness and surface area thereof along the fin 52.

In another form of the present invention, the catalyst washcoat is applied after the fin 52 and the core 54 are placed within the tube. Accordingly, the fin 52 is wound around the core 54, and the wound fin 52 and core 54 are then placed within the tube to form the tube assembly. The catalyst washcoat is then applied to the entire tube assembly. Similarly, the catalyst washcoat may be tailored to the specific flow path and mixing requirements by varying the thickness and surface area thereof within the tube assembly. As a result, the catalyst washcoat may be applied either before or after assembly of the fin 52 and the core 54 within the tube in accordance with the teachings of the present invention.

Referring to FIG. 7A, yet another form of the present invention employs a plurality of fins 53 that are secured to the core 54 as shown. The fins 53 are secured to the core 54 as previously set forth, and a plurality of different fins 53a-d may be employed according to specific fuel processing reactor requirements. Further, the fins 53a-d may be spaced apart a distance, as shown in FIG. 7A, or the fins 53a-d may abut one another along the core 14 as illustrated in FIG. 7B, according to flow path requirements within the fuel processing reactor.

The fins 53 may comprise various material types, such as steels or other metal alloys that can be shaped, in order to customize the flow path within the reactor and to further provide for efficient mixing of the gas stream therein. Furthermore, the geometry of the fins 53 may be varied to further customize the flow path and to facilitate efficient mixing. For example, the fins 53 may comprise geometries including, but not limited to, crest fins, lanced fins, herringbone fins, perforated fins, louvered fins, and/or variegated fins, or a combination thereof. A variety of material types and geometries may be employed along a single core 54, and/or the material types and geometries may be varied between different sections of the fuel processing reactor according to system requirements.

The fins 53 are similarly coated with a catalyst washcoat as previously described; wherein the catalyst washcoat may be applied either before or after assembly of the fins 53 and the core 54 within the tube. Accordingly, the catalyst washcoat may also be tailored to the specific application requirements by varying the thickness and surface area thereof within the assembly and/or along the fins 53.

The present invention provides a customized flow path substrate wherein specific fin materials and geometries are tailored in order to customize a flow path and to facilitate efficient mixing of gases within a fuel processing reactor. As a result, a fuel processing system may operate more efficiently at a lower cost and weight with the tailored flow paths and mixing provided by the teachings of the present invention.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A substrate for use in a catalyst bed comprising:
a core member;
a fin secured to the core member, said fin being helically wound around said core member; and
a catalyst material covering at least a portion of said fin.

2. The substrate of claim 1, wherein said fin has a geometry selected from a group consisting of crest fins, lanced fins, herringbone fins, perforated fins, louvered fins, and variegated fins.

3. The substrate of claim 1, wherein the geometry selected prevents one layer of the helical winding from “nesting” or collapsing into another adjacent layer due to geometrical design or shape similarity.

4. The substrate of claim 1, further comprising a tube in which said core member and said fin are inserted.

5. A substrate for use in a catalyst bed comprising:
a core member;
a plurality of fins secured to said core member, wherein each fin comprises a material; and
a catalyst material covering at least a portion of each fin,
wherein the material of each fin is varied to customize a flow path and to provide for efficient mixing of gases within the fuel processing reactor.

6. The substrate of claim 5, wherein a geometry of each of said plurality of fins is varied to further customize the flow path and to provide for efficient mixing.

7. The substrate of claim 5, wherein a geometry of said plurality of fins is selected from a group consisting of, but not limited to, crest fins, lanced fins, herringbone fins, perforated fins, louvered fins, and variegated fins.

8. The substrate of claim 5, wherein said plurality of fins are spaced a distance apart.

9. The substrate of claim 5, wherein said plurality of fins abut one another.

10. The substrate of claim 5, wherein said plurality of fins are helically wound around said core member.

11. The substrate of claim 10, further comprising a tube in which said core member and said plurality of fins are inserted.

12. A method of forming a substrate for a reactor of a fuel processor comprising the steps of:
(a) securing at least one fin to a core;
(b) coating at least a portion of the fin with a catalyst material;
(c) winding the fin around the core; and
(d) placing the fin and the core in a tube.

13. The method of claim 12, wherein said at least one fin has a geometry selected from a group consisting of, but not limited to, crest fins, lanced fins, herringbone fins, perforated fins, lowered fins, and variegated fins.

14. A method of forming a substrate for a reactor of a fuel processor comprising the steps of:
(a) securing at least one fin to a core;
(b) winding the fin around the core;
(c) placing the fin and the core in a tube; and
(d) coating the fin with a catalyst material.

15. The method of claim 14, wherein said at least one fin has a geometry selected from a group consisting of, but not limited to, crest fins, lanced fins, herringbone fins, perforated fins, lowered fins and variegated fins.

16. A method of forming a customized flow path substrate for a reactor of a fuel processor comprising the steps of:
(a) securing a plurality of fins to a core;
(b) coating at least a portion of the fins with a catalyst material;
(c) winding the fins around the core; and
(d) placing the fins and the core in a tube.

17. The method of claim 16, wherein a geometry of the fins is varied.

18. The method of claim 16, wherein a material of the fins is varied.

19. The method according to claim 16, wherein said plurality of fins are spaced apart.

20. The method according to claim 16, wherein said plurality of fins abut one another.

21. A method of forming a customized flow path substrate for a reactor of a fuel processor comprising the steps of:
(a) securing a plurality of fins to a core;
(b) winding the fins around the core;
(c) placing the fins and the core in a tube; and
(d) coating the fins with a catalyst material.

22. The method of claim 21, wherein a geometry of the fins is varied.

23. The method of claim 21, wherein a material of the fins is varied.

24. The method of claim 21, wherein said plurality of fins are spaced apart.

25. The method of claim 21, wherein said plurality of fins abut one another.

26. A fuel processing reactor for use in a fuel processor, comprising:
a housing defining a reaction chamber having an inlet and an outlet; and
a plurality of tube assemblies disposed in said reaction chamber, said tube assemblies including a core member having at least one fin wrapped around said core member, said core member and said at least one fin being disposed in a tube, said at least one fin being at least partially coated with a catalyst material.

27. The fuel processing reactor according to claim 26, wherein said at least one fin includes a plurality of fins attached to and wrapped around said core member.

28. The fuel processing reactor according to claim 27, wherein a geometry of said plurality of fins is varied.

29. The fuel processing reactor according to claim 27, wherein a material of said plurality of fins is varied.

30. The fuel processing reactor according to claim 27, wherein said plurality of fins are spaced apart.

31. The fuel processing reactor according to claim 27, wherein said plurality of fins abut one another.
